(19) United States
(12) Patent Application Publication
(10) Pub. No.: US 2007/0065171 A1
(43) Pub. Date: Mar. 22, 2007

(54) Image forming apparatus

(76) Inventors: Yasushi Koshimura, Tokyo (JP); Junichi Koiso, Tokyo (JP); Yoshiaki Kondoh, Tokyo (JP)

Correspondence Address: CANTOR COLBURN, LLP, 55 GRIFFIN ROAD SOUTH, BLOOMFIELD, CT, 06002, US

(21) Appl. No.: 11/438,661

(22) Filed: May 22, 2006

(30) Foreign Application Priority Data
Sep. 22, 2005 (JP) JP2005-275383

(51) Int. Cl. G03G 21/00

(52) U.S. Cl. 399/99

(57) ABSTRACT

An image forming apparatus includes: a developing unit which develops a latent image formed by a writing unit on an image carrier which has been uniformly charged by a charger; and a developer sucking section, the developer sucking section comprising a ventilation duct having a sucking opening provided in the vicinity of a position to which the image carrier and a developing roller of the developing unit are closed for collecting a floating developer that is splashed from the developing roller, and an exhaust duct connected with the ventilation duct and provided with a suction blower, a filter, and an exhaust opening; wherein a barrier section for catching a part of the floating developer is provided in the ventilation duct.

This application is based on Japanese Patent Application No. 2005-275383 filed on Sep. 22, 2005, which is incorporated by reference.

### BACKGROUND OF THE INVENTION

The present invention relates to an image forming apparatus of an electro-photographic system having a developer sucking section for sucking and collecting floating developer when developing images.

One of the problems associated with an electro photographic image forming apparatus is developer splash from a developing unit.

Developer, electrostatic charge amount of which has fallen splashes substantially in a tangential direction of the photoreceptor drum from an adjacent point of a photoreceptor drum as an image carrier and a developing sleeve (a developing roller) as a developer bearer by the rotation of the developing sleeve (the developing roller). Accordingly, as described in Japanese Patent Applications Open to Public Inspection Nos. H08-220882 and 2005-55689, proposed are devices for preventing image forming process members (structural elements) and transfer materials (sheets) from dirtying by forming a sucking opening of a ventilation duct in the suction section for sucking the floating developer in the outside of the developing unit and in the downstream of rotational direction of the developing roller.

A filter is provided near an exhaust opening to suck and collect the floating toner in the duct by the help of a suction blower. However, since the filter is clogged with toner and collection performance and exhaust performance quickly come down. Further, since the frequent filter replacement and cleaning and the removal and collection of floating toner must be conducted, the situation where the image forming apparatus has to be stopped frequently occurs and which results in a non-effective state. Namely, strongly demanded is the improvement of the durability, such as prolongation of the cleaning and maintenance interval of the filter in the image forming apparatus of the electro-photographic system, in other words, the prolongation of the maintenance cycle of the filter is strongly demanded.

Consequently, it is preferable to make the area of the filter large. However, there is a problem that the size of the image forming apparatus becomes large. Further, when trying to improve the clogged filter by making the mesh of the filter rough, there is another problem that the toner leaks out of the apparatus.

### SUMMARY OF THE INVENTION

An object of the present invention is to provide an image forming apparatus having a high quality image, a developer sucking section with excellent maintenance performance and a high collection-efficiency of floating developer, a compact sized shape and a long maintenance cycle and excellent maintenance operability.

The object of the present invention will be attained by the following embodiments.

In accordance with one of the aspect of the present invention, an image forming apparatus comprising: a developing unit which develops a latent image formed by a writing unit on an image carrier which has been uniformly charged by a charger; and a developer sucking section, the developer sucking section comprising a ventilation duct having a sucking opening provided in the vicinity of a position to which the image carrier and a developing roller of the developing unit are closed for collecting a floating developer that is splashed from the developing roller, and an exhaust duct connected with the ventilation duct and provided with a suction blower, a filter, and an exhaust opening; wherein a barrier section for catching a part of the floating developer is provided in the ventilation duct.

### BRIEF DESCRIPTION OF THE DRAWING

FIG. 1 illustrates a cross-sectional view of the configuration of the main portion of one of the embodiment of a color image forming apparatus having the developer sucking section of the present invention.

FIG. 2 illustrates a side cross-sectional view of the present invention.

FIG. 3 illustrates a plan view seen from the lower side of the present invention shown in FIG. 2.

FIG. 4 illustrates a side cross-sectional view of an example of a developer sucking section.

FIG. 5 illustrates a graph showing the limitation of clogged filter and the number of printing paper sheets when collecting floating developer by using a filter only.

FIG. 6 illustrates a graph showing the limitation of clogged filter and the number of printing paper sheets when collecting floating developer by using a filter together with a developer collecting box.

### DETAILED DESCRIPTION OF THE PREFERRED EMBODIMENT

Hereinafter, the embodiment of the present invention will be described. The description in this specification does not limit the technical scope of the claims of the present invention and the meaning of the words used in the specification. Further, hereinafter, the decisive description in the embodiment of the present invention intends to present the best mode, but not to limit the meaning of the words and the technical scope of the present invention.

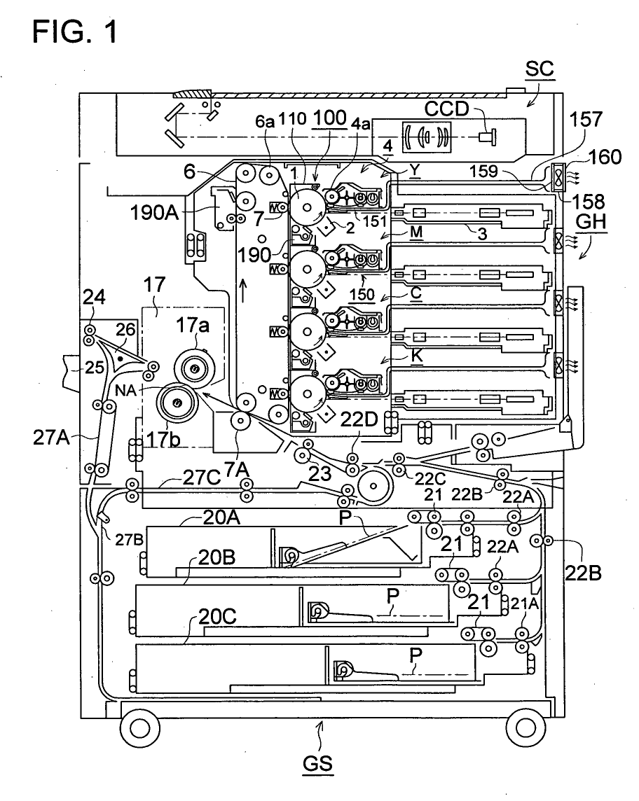

(1) An image forming apparatus of the present invention will be described by using FIG. 1 below.

According to FIG. 1, an image forming apparatus GS comprises the main body of the image forming apparatus GH and an image scanning apparatus SC provided in the upper portion of the main body of the image forming apparatus GH.

The main body of the image forming apparatus GH is called a tandem type color image forming apparatus. An image forming unit for forming each color toner image of Yellow, Magenta, Cyan and Black is arranged along the moving direction of the intermediate transfer member. After transferring and superimposing the color toner image formed on the image carrier of each image forming unit onto the intermediate transfer member in piles, the transferred image on the intermediate transfer member is transferred concurrently onto a transfer material.

In FIG. 1, a document image placed on the image scanning apparatus SC provided upper portion of the main body of the image forming apparatus is scanned and exposed by an optical system. The light beams enter into a line image sensor CCD. The analog signals converted from light beams in the CCD (photo-electric conversion) is sent as an image signal to an exposure optical system 3 as an image writing unit after analog process, Analog to Digital conversion, a shading correction and image data compression process are applied to the analog signals.

Further, in FIG. 1, in the circumference of a intermediate transfer belt 6 being a intermediate transfer member, four pairs of process units 100 of Yellow (Y), Magenta (M), Cyan (C) and Black (K) used of color image formation of each color are disposed in series in a vertical direction along the interim transfer belt 6 against the rotational direction of the interim transfer belt 6 as shown by the arrow in FIG. 1.

Each process unit of the four pairs of process units 100 has a common structure. Each process unit comprises a photoreceptor drum 1 as an image carrier, a charger unit 2 as a charger, an exposure optical system 3 as an image writing unit, a developing unit 4 which will be detailed later and a photoreceptor cleaning device 190 as an image carrier cleaning unit.

The photoreceptor drum 1 as an image carrier is a carrier having a photoconductive layer of an organic photoconductive layer (OPC) having thickness (the thickness of membrane) of 20-40 μm as a photoconductive layer on the circumference of the base substrate formed in a cylindrical shape of a metal member such as aluminum having diameter of, for example, about 40-100 mm. The power of driving source (not shown) rotates the photoreceptor drum 1 in the direction as shown by an arrow in FIG. 1 at a line velocity of, for example, about 80-280 mm/s, preferable 220 mm/s under the condition that the conductive layer is shorted to the ground.

The charging unit 2 as a charger, the exposure optical system 3 as an image writing unit and a set of image forming section configured by the developing unit 4 are disposed around the photoreceptor drum 1.

The charger unit 2 as a charger is arranged in a direction perpendicular to the moving direction of the photoreceptor drum 1 (the direction perpendicular to the paper sheet on which FIG. 1 is drawn) and opposed to the photoreceptor drum 1. The charger unit 2 comprises a discharging wire as a corona discharge electrode for giving predetermined voltage to the organic photoconductive layer of the photoreceptor drum 1, the discharging wire giving a uniform voltage to the photoreceptor drum 1 by conducting a charge action by performing corona discharge of the same polarity as toner (in this embodiment, it is a minus charge).

The exposure optical system 3 as an image writing unit forms an electro-static latent image corresponding to the document image on the photoreceptor layer on the surface of the photoreceptor drum 1 by rotating and scanning laser beams emitted from a semiconductor laser (LD) (not shown) and exposing the photoreceptor drum 1 (image writing) based on electric signals corresponding to the image signals through a fθ lens (no-symbol) and a reflection mirror (no-symbol).

Each developing unit 4 as a developing means stores the two ingredients developer of each color of Yellow (Y), Magenta (M), Cyan (c) or Black (K) which has been charged with the same charged polarity as the photoreceptor drum 1 and comprises a developing roller 4a being a developer image carrier formed by cylindrical and nonmagnetic stainless or aluminum material having a thickness of 0.5-1 mm and an outer diameter of 15-25 mm. The developing roller 4a is arranged so that a pressing roller (not shown) keeps the distance between the developing roller 4a and the photoreceptor drum 1 at the predetermined distance, for example, 100-1000 μm to maintain the non-contact state. The developing roller 4a is arranged to rotate in the same rotational direction as the photoreceptor drum 1. When conducting exposure, an inverting development is conducted against the exposing section on the photoreceptor drum 1 by applying a direct current voltage having the same polarity as the toner (in this embodiment, it is minus polarity) or a bias voltage being a direct current voltage on which an alternate current voltage is superimposed onto the developing roller 4a.

With regard to the developer (toner) used for the inverting development, polymerization toner is preferably used. The toner splashed between the photoreceptor drum 1 and each developing unit 4 are sucked by a suction blower 158 through a developer sucking section 150, captured by a ventilation duct 151 and exhaust duct 157 and the air including splashed toner is exhausted out of the image forming apparatus.

The intermediate transfer belt 6 being an intermediate transfer member uses a seamless resin belt member having half-electro-conductivity having a volume resistibility of about 1.0×10⁷-1.0×10⁹ Ω·cm, and the surface resistibility of about 1.0×10¹⁰-1.0×10¹² Ω/□. For example, the intermediate transfer belt 6 is a resin film substrate having a half-electro-conductivity, the thickness of which is 0.05-0.5 mm, the resin film substrate being structured by engineering plastics into which a electro-conductive material is dispersed, the engineering plastics being denatured polyimide, heat curing polyimide, ethylene-tetrafluoroethylene copolymer, poly vinylindene fluoride and nylonalloy. With regard to the substance of the intermediate transfer belt 6, other than these substances, half-electro-conductivity rubber belt having a thickness of 0.5-2.0 mm can also be used for the intermediate transfer belt 6, the half-electro-conductivity rubber belt being structured by silicon rubber or ulethane rubber into which electro-conductive material is dispersed. The intermediate transfer belt 6 is winded over a plurality of rollers including a tension roller 6a and supported in the vertical direction so that the intermediate transfer belt 6 freely rotates. With regard to the intermediated transfer substance, a drum shape substance may be used.

A first transfer roller 7 (a primary transfer roller) as the first transfer device of each color is structured by electro-conductive material having formed into a roller shape for which, for example, foamed rubber such as silicon and ulethane is used. The first transfer roller 7, which sandwiches the intermediate transfer belt 6 is provided opposed to the photoreceptor drum 1 of each color, and press the back surface of the intermediate transfer belt 6 to form a transfer area between the photoreceptor drum 1 and the intermediate transfer belt 6. The constant direct current having an inversed polarity (in this embodiment, plus polarity) of the toner is applied onto the first transfer roller 7 by constant current control. The transfer electric field formed in the transfer space transfers the toner image on the photoreceptor drum 1 to the intermediate transfer belt.

Image forming process will be described below.

A photoreceptive motor (not shown) starts rotating the Y (Yellow)-photoreceptor drum 1 in the direction shown by arrow in FIG. 1, and the Y-charging unit 2 gives voltage to Y-photoreceptor drum 1 triggered by the start of image recording. After the voltage is given to the Y-photoreceptor drum 1, since the Y-exposure optical system 3 conducts exposure (writing an image) by applying the first color signals, namely electric signals corresponding to Y-image data onto the Y-photoreceptor drum 1, an electro-static latent image corresponding to the Yellow (Y) image is formed on the Y-photoreceptor drum 1. The Y-developing unit 4, inversely develops this latent image and a toner image configured by the Yellow (Y) toner is formed on the Y-photoreceptor drum 1. The Y-toner image formed on the Y-photoreceptor drum 1 is transferred onto the intermediate transfer belt 6 by the first transfer roller 7 as the first transfer device.

Then, the M-charging unit 2 gives voltage to M-photoreceptor drum 1. After the voltage is given to the M-photoreceptor drum 1, since the M-exposure optical system 3 conducts exposure (writing an image) by applying the first color signals, namely electric signals corresponding to M-image data onto the M-photoreceptor drum 1, an electro-static latent image corresponding to the Magenta (M) image is formed on the M-photoreceptor drum 1. The M-developing unit 4, inversely develops this latent image and a toner image configured by the Magenta (M) toner is formed on the M-photoreceptor drum 1. The M-toner image formed on the M-photoreceptor drum 1 is transferred onto the intermediate transfer belt 6 by the first transfer roller 7 as the first transfer device.

Based on the same process described above, a toner image of Cyan (C) toner formed on the C-photoreceptor drum 1 and a toner image of Black (K) toner formed on the K-photoreceptor drum 1 are successively superimposed onto the intermediate transfer belt 6. Consequently, a superimposed toner image formed by Y, M C and K toners are formed on the circumference surface of the intermediate transfer belt 6.

A photoreceptor cleaning device 190 as an image carrier-cleaning device cleans the toner left on the circumference surface of each photoreceptor drum 1 after the transfer operation.

Recording paper sheets P as a transfer member stored in paper feeding cassettes 20A, 20B and 20C are fed by a conveyance roller 21 and paper feeding roller 22A provided with each paper feeding cassettes 20A, 20B or 20C. The recording paper sheets P are conveyed to the second transfer roller 7A as a second transfer device to which the inversed polarity voltage against the toner is applied (in this embodiment, it is plus polarity) through conveyance rollers 22B, 22C, 22D and a registration roller 23. The superimposed colored toner image (a color image) formed on the intermediate transfer belt 6 is transferred onto the recording paper sheet P at once.

A heating roller 17a of the fixing apparatus 17 and a pressing roller 17b press the recording paper sheet P onto which the color image has been transferred with heat to fix the image on the recording paper sheet P. Then, ejecting roller pair 24 sandwiches the recording paper sheet P to eject and place them onto a sheet ejection tray 25.

Further, after the second transfer roller 7A as a second transfer device has transferred the color image onto the recording paper P, an intermediate transfer cleaning device 190a as an intermediate transfer cleaning device removes the residual toner from the intermediate transfer belt 6 which has separated the recording paper sheet P by applying curvature separation.

Here, the image forming apparatus above has been described based on the color formation process. However, the present invention includes the monochromatic image formation.

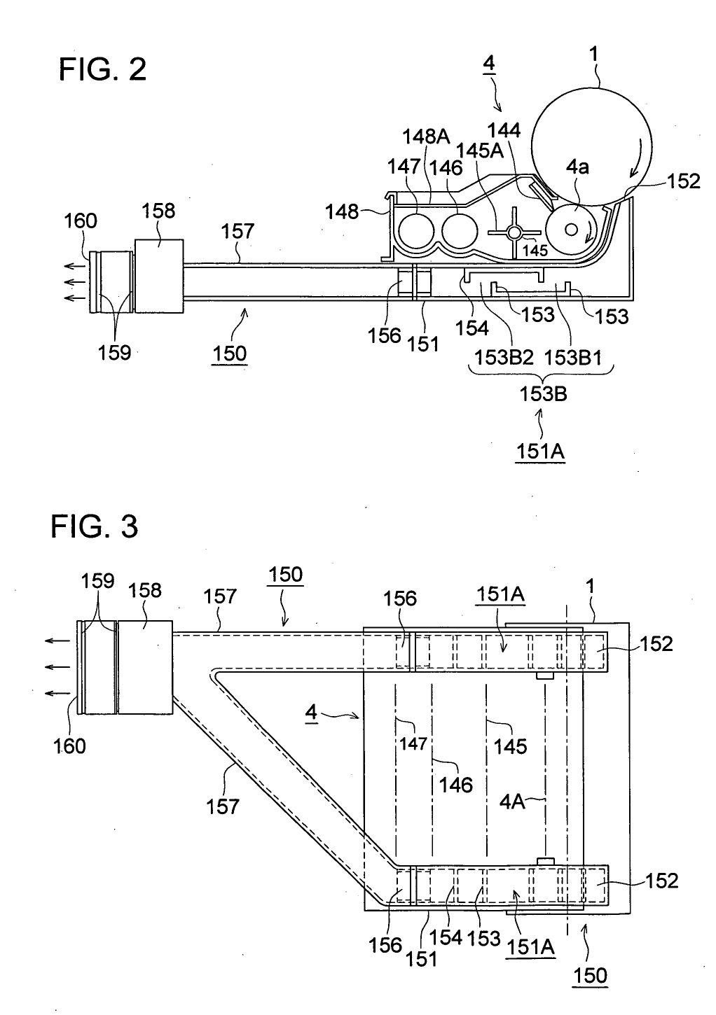

(2) Next, the developer sucking section 150 will be described below by using FIGS. 2 and 3. FIG. 2 illustrates the sectional view of the developer sucking section of the present invention. FIG. 3 illustrates a plan view seen from the lower side of the present invention shown in FIG. 2.

As shown in FIG. 2, the developing unit 4 includes a developing roller 4a so that the developing roller 4a is disposed parallel and opposed to the photoreceptor surface of the photoreceptor drum 1 having the outer diameter of, for example, 100 mm.

The developing unit 4 includes two-component developer and a developing roller 4a rotating the same rotational direction (the reverse direction each other in the tangential direction) against the rotational direction of the photoreceptor drum 1 at the developing position while keeping a predetermined distance to the photoreceptor drum 1.

In the developing unit 4, numeral 148 denotes a housing being a developer storage section for storing two-component developer including toner and carrier; 4a denotes a developing roller being a developer bearer having a magnet roll (not shown) therein; 144 denotes a layer thickness regulation member structured by magnetic material for regulating the developer thickness of the developer roller 4a at a predetermined amount; 145 denotes a conveyance and supply roller; and 146 and 147 denote a pair of stirring screws.

The developing roller 4a being a developer bearer structured by a cylindrical member having an outer diameter of 8-60 mm of aluminum material or stainless material. The developing roller 4a is disposed opposed to the photoreceptor drum 1 and rotates clockwise when photoreceptor drum 1 rotates (clockwise in FIG. 2) while pressing rollers (not shown) provided both ends of the developing roller 4a keep the distance between the developing roller 4a and the photoreceptor drum 1 at a predetermined distance. When setting the outer diameter of the developing roller 4a not more than 8 mm, it becomes impossible to form a magnet roll (not shown) having at least five magnetic poles of N1, S1, N2, S2 and N3. When setting the outer diameter of the developing roller 4a more than 60 mm, the size of the developing unit 4 becomes large. Particularly, in the case of the color printer (referring to FIG. 1) having a plurality of developing units 4, the space, which the developing unit occupies becomes large. As a result, the diameter of photoreceptor drum 1 becomes large and the size of the image forming apparatus GS becomes large due to the increase of the photoreceptor drum 1.

The magnet rolls (not shown) are provided inside the developing unit 4a. For example, a plurality of magnet poles N1, N2, N3, S1 and S2 are alternately disposed (not shown) and fixed coaxially on the axis of the developing unit 4a and form magnetic field along the circumference surface of the non-magnetic sleeve.

The layer thickness regulation member 144 is structured by, for example, stainless material shaped in a bar or a plate. The layer thickness regulation member 144 is disposed opposed to the N-pole of the magnet rolls (not shown) with keeping a predetermined distance to the developing unit 4a to stably and uniformly regulate the layer thickness of the two-component developer formed on the circumference surface of the developing roller 4a. Particularly, present system utilizing a magnetized layer thickness regulation member 144 is excellent in forming a thin layer of developer on the surface of the developing roller 4a.

The conveyance and supply roller 145 conveys developer removed from the developing roller 4a to the stirring screw 146 and simultaneously supplies the developer stirred by the stirring screw 146 to the layer thinness regulation member 144. Numeral 145A denotes a blade for conveying developer, which is provided with the conveyance and supply roller 145.

The stirring screws 146 and 147 rotate in the direction opposed to each other to stir and uniformly mix the two-component developer including toner and magnetic carrier in the developing unit 4 with a predetermined toner component ratio.

The toner is supplied into the housing 148 from a toner supply opening (not shown) provided in a top plate 148a located upper portion of the housing 148, the toner supply opening being located upper portion of the stirring screw 147. The stirring screws 146 and 147 rotating different directions each other stir and mix the toner with developer stored in the housing 148 to make developer having an uniform toner concentration. The conveyance and supply roller 145 conveys the developer to the layer thickness regulation member 144 for regulating thickness of toner layer at a predetermined thickness and supplies the toner to the outer surface of the developing roller 4a. The rest of the toner other than the toner used for developing the latent image formed on the photoreceptor drum 1 is removed by the developing roller 4a and conveyed back to the stirring screw 146 by the conveyance and supply roller 145. A non-contact developing method which applies a developing bias voltage to which alternate current (AC) bias voltage is superimposed reversibly develops the electro-static latent image on the photoreceptor drum 1.

As shown in the side sectional view shown in FIG. 2 and a plane view shown in FIG. 3, a developer sucking section 150 of the present invention is provided adjacent to the developing unit 4. The developer sucking section 150 comprises a ventilation duct 151 and an exhaust duct 157. The ventilation duct 151 is fixed along the lower portion of the housing 1 by a fixing member (not shown). A sucking opening 152 for sucking floating developer is provided on the upper end of the ventilation duct 151. A connecting member 156 connects the exhaust duct 157 with the opening of the connecting end located at the other side of the sucking opening 152 of the ventilation duct 151 in the developer sucking section 150. A suction blower 158 for sucking floating developer and a filter 159, which can be freely removed and inserted, the filter being provided in rear side of the suction blower 158, are arranged adjacent to the edge of an exhaust opening 160 of the exhaust duct 157. The ventilation duct 151 is arranged to be removed by removing the fixing member to the housing 148 and releasing the connecting member 156. By removing the ventilation duct 151 from the housing 148, a cleaning and maintenance operation can be easily conducted.

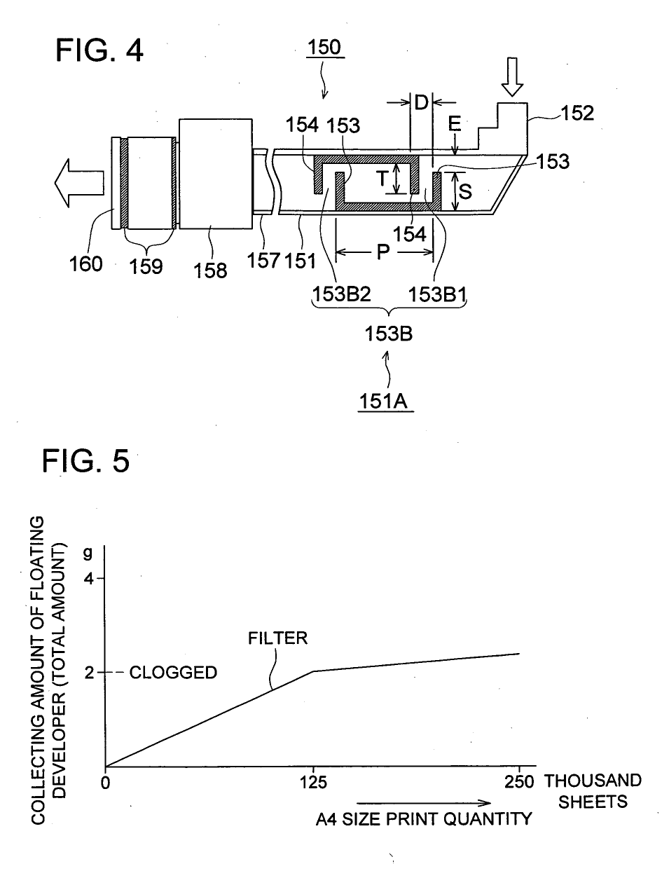

As shown in the side cross-sectional view of the developer sucking section illustrated in FIG. 4, the ventilation duct 151 comprises at least a barrier section 151A. As shown in the side cross-sectional view illustrated in FIG. 4, the barrier section 151A includes at lease one rib for each inner wall surface, each inner wall surface is opposed each other. A rib 153 located on one side of the inner wall surface is opposed to a rib 154 located on the other side of the inner wall surface so that the rib 153 and the rib 154 are shifted each other in the flow-direction of the ventilation duct 151. Further an influx opening and an efflux opening are formed so that the length of a projection which is projected to the inner wall surface of the other side of the rib 154 or one side of the rib 153 is set less than the distance between both inner wall surfaces which are opposed each other to form a flow path for generating swirl together with the inner wall surface. The barrier 151 forms at least a developer collecting box 153B.

The developer sucked from the sucking opening 152 is conveyed through a developer sucking section 150 according to a flow path indicated by an arrow and captured by a developer collecting box 153B and the filter 159.

Namely, when there are plural developer collecting boxes, a whirl occurs at least in one developer collecting box 153B in either the collecting box 153B1 or 153B2. As a result, floating toner tends to be accumulated in the developer collecting box. Then the developer collecting box is arranged to be collected when reached at the predetermined copy-cycle. The floating developer, which cannot be collected by the developer collecting box 153B is collected by the filter 159.

The influx area of the developer collecting box 153B, which is formed by the rib 153 of the one side of the inner wall surface and the other inner wall surface opposed to the one side of the inner wall surface is arranged to be 10-25% of the cross-sectional area of the air-flow of the ventilation duct 151.

When the influx opening is formed by the rib 153 of the one side of the inner wall and the other inner wall being opposed to the one side of the inner wall, the efflux opening is formed by the rib 154 of the other side of the inner wall and the one side of the inner wall opposed to the other side of the inner wall, and at least one developer collecting box 153B is formed together with the ventilation duct 151, the length of the projection T from the inner wall surface of the rib 154 on the other inner wall surface is set 1.5-5.0 times the opening length E in the influx opening in the rib-projection direction. The distance D between both developer collecting box is set 1.0-3.0 times the opening length E in the influx opening in the rib-projection direction. The pitch of the rib 153 of the one side of the inner wall surface when plural developer collecting boxes adjoin each other, or the pitch between ribs 154 of the other inner wall surface is set not less than 0.8 times the projection of the rib 153 forming the influx opening. By setting the allotment of the rib as described above, the maintenance cycle, which will be described later has been boldly prolonged.

With regard to the suction blower 158, relatively less expensive axial flow fan is used in this embodiment. However, it is not limited to this.

The ventilation duct 151 forming at least one developer collecting box 153B is arranged to be capable of being removed from the developing unit 4. Accordingly, collected developer collected by forming whirl can be easily collected and at the same time cleaning can be easily conducted.

The following is one of example of the developer sucking section 150. The plural ventilation ducts 151 are provided (in this embodiment, two ventilation ducts are provided) and each connection opening of each ventilation duct is connected to the connection opening corresponding to one ventilation duct 157. The suction blower 158 collects the floating developer into the developer collecting boxes 153B1 and the filter 159 and exhausts others through the exhaust opening 160. However, the number of the ventilation duct 151 is not limited to plurality and it may be single.

By adopting the configuration of the present invention as described above, the dirt of each structure member of the image forming apparatus and transfer material caused by floating developer in the circumference of the developing unit 4 and further in the image forming apparatus GS can be avoided. At the same time, since the amount of the floating developer collected by the filter 159 provided in front of and the rear side of the suction blower 158 located in the edged of the exhaust duct 157 extremely decreases in response to the increase of the collected toner in the developer collecting box in the exhaust duct 157, the time to reach the point where the filter 159 is clogged by the floating developer can be prolonged. As a result, the maintenance cycle can be prolonged and the operation ratio can be boldly improved.

As shown in FIG. 5, since formally only the filter 159 collects floating developer (toner), clogged phenomenon occurred when total amount reaches to 2 g, reached to the situation where the filter 159 cannot collect floating toner any more and the dirt inside of the apparatus deteriorates. This corresponds to the time when 120,000-130,000 sheets of paper have been printed or copied based on the A4 size paper sheet having normal printing characters on one page. This time flame used to be used as a cleaning check cycle.

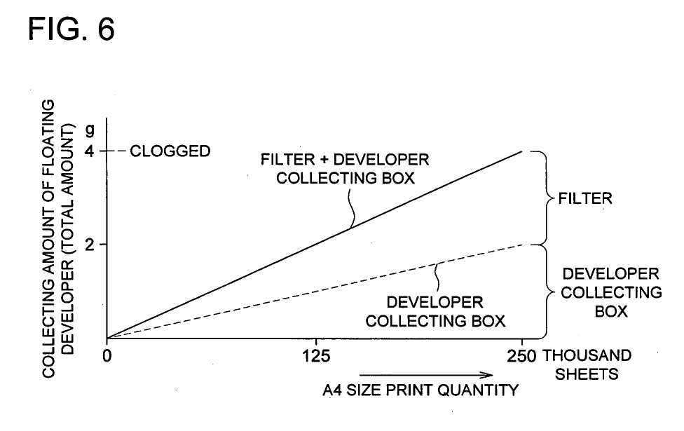

When the filter 159 and the developer collecting box 153B as at least one barrier section 151A are used at the same time as the present invention, as shown in FIG. 6, it become possible to print or copy 250,000-260,000 sheets of paper (number of copying sheets) which can be printed or copied based on the A4 size paper sheet having normal printing characters on one page until the filter reached to the situation limitation where the filter is clogged with the floating developer.

As described above, since a filter and a developer collecting box work together to collect the floating developer, the life of the filter and the maintenance cycle become double and the operation ration of a developing unit and an image forming apparatus boldly increases.

Further, it becomes possible to further increase the amount of collected toner by providing plural developer collecting boxes 153B1 and 153B2 as the developer collecting box 153B in the ventilation duct comparing with the situation where a single developer collecting box is utilized.

The air pressure difference between the influx opening and the efflux opening of the developer collecting box 153B and the air pressure differences between developer collecting boxes 153B which are continuously provided each other are set 50 Pa.

Further, since the developer sucking section 150 and the ventilation duct 150 are arranged to be easily removed, it becomes easy to clean the sucking opening 152 and to conduct the every maintenance for preventing the floating of toner.

The number of filter in the developing unit may be one. However, as shown in FIGS. 2, 3 and 4, the number of filter in the developing unit may be not less than two.

What is claimed is:

1. An image forming apparatus comprising:
(a) a developing unit which develops a latent image formed by a writing unit on an image carrier which has been uniformly charged by a charger; and
(b) a developer sucking section, the developer sucking section comprising
(1) a ventilation duct having a sucking opening provided in the vicinity of a position to which the image carrier and a developing roller of the developing unit are closed for collecting a floating developer that is splashed from the developing roller, and
(2) an exhaust duct connected with the ventilation duct and provided with a suction blower, a filter, and an exhaust opening,
wherein a barrier section for catching a part of the floating developer is provided in the ventilation duct.

2. The image forming apparatus of claim 1, wherein the barrier section constituting a developer collecting box which has an influx opening and an efflux opening, comprises at least one rib provided on each of two inner wall surfaces which face each other in the ventilation duct, the at least one rib provided on one inner wall surface and other rib provided on the other inner wall surface are spaced alternately with each other with respect to a direction of a flow path so as to generate a swirl with the inner wall surfaces.

3. The image forming apparatus of claim 2, wherein a length of the rib projecting toward the other inner wall surface is set less than a distance between the two wall surfaces.

4. The image forming apparatus of claim 2, wherein one rib and the other rib are overlapped each other with respect to the direction of the flow path.

5. The image forming apparatus of claim 2, wherein an area of the influx opening of the developer collecting box which is formed by the rib of the one inner wall surface and the other inner wall surface, is 10 to 25% of a cross-sectional area in the ventilation duct.

6. The image forming apparatus of claim 2, wherein when at least one developer collecting box is formed by the influx opening which is formed by the rib of the one inner wall surface and the other inner wall surface, the efflux opening which is formed by the rib of the other inner wall surface and the one inner wall surface, and inner surfaces of the ventilation duct, a length of the rib projecting from the other inner wall surface is 1.5 to 5.0 times an opening length of the influx opening in a projecting direction of the rib in the influx opening, and when a plurality of adjoining developer collecting boxes are formed, a pitch between the ribs provided on one inner wall surface is 0.8 or more times a projecting length of the rib which forms the influx opening.

7. The image forming apparatus of claim 2, wherein a plurality of ribs are provided on each of inner wall surfaces which face each other so that a plurality of developer collecting boxes are continuously formed in one suction blower.

8. The image forming apparatus of claim 2, wherein a pressure difference between the developer collecting boxes is approximately 50 Pa.

9. The image forming apparatus of claim 1, wherein the suction blower is an axial flow fan.

10. The image forming apparatus of claim 1, wherein a plurality of ventilation ducts are provided, each of which is connected to a corresponding connection opening of the exhaust duct, the floating developer is collected in the barrier section and the filter by the suction blower, and gas accompanied with the floating developer is exhausted from the exhaust opening.
